(19) United States
(12) Patent Application Publication
(10) Pub. No.: US 2019/0053664 A1
(43) Pub. Date: Feb. 21, 2019

(54) Cooking Smoker

(71) Applicant: Darren Chapman, Houston, TX (US)

(72) Inventor: Darren Chapman, Houston, TX (US)

(21) Appl. No.: 15/681,146

(22) Filed: Aug. 18, 2017

(51) Int. Cl. A47J 37/07; A23B 4/052

(52) U.S. Cl. CPC A47J 37/0754; A23B 4/052

(57) ABSTRACT

A cooking smoker having a housing which defines a smoke chamber and separate fire box. Flow of air and smoke through the cooking smoker is governed by a fan which displaces air and smoke within the smoke chamber through a chimney which is at or below the level at which air enters the cooking smoker.

### BACKGROUND OF THE INVENTION

### 1. Field of the Invention

The invention relates generally to the design of outdoor cooking smokers.

### 2. Description of the Related Art

Outdoor cooking smokers are popular devices for smoking meats and other foods. Solid combustible fuel, such as charcoal and wood is burned within the smoker. The heat from combustion of the fuel cooks the food while the smoke imparts a smoky flavor to the food. Smokers are typically intended to cook food over a long period of time at relatively low and constant temperatures. Conventional cooking smokers retain the food over the fuel in a substantially enclosed smoker housing to allow the heat and smoke to rise toward the food. A chimney or vent is provided at or near the very top of the smoker to allow air and smoke to be naturally released from the smoker.

### SUMMARY OF THE INVENTION

The invention provides a cooking smoker which allows control of cooking temperature via air flow and has other features. An exemplary cooking smoker is described which includes an outer housing which encloses a smoke chamber and a fire box which is separated from the smoke chamber by a bulkhead. The outer housing is preferably insulated. The smoke chamber preferably supports racks or trays for food to be cooked and smoked. The fire box contains fuel, such as charcoal and wood which burns to cook and smoke the food.

Air and smoke from the fire box must enter the smoke chamber at the upper end of the smoke chamber. Inner side walls are positioned a spaced distance from the outer housing in order to define a smoke channel therebetween which allows air and smoke to rise from the fire box and flow through the smoke channel and into the upper portion of the smoke chamber.

Air and smoke within the smoke chamber must exit the smoke chamber below the smoke chamber. In other words, air and smoke exiting the smoke chamber through the housing will exit the housing at a point that is lower than the floor of the smoke chamber and preferably below the bulkhead which separates the smoke chamber from to the fire box. In a described embodiment, a chimney which allows air and smoke to exit the smoke chamber is located proximate the lower portion of the smoke chamber. Further, the chimney is provided with a chimney hood which directs air and smoke downwardly once outside of the housing so that the air and smoke must pass below the level of the lowest portion of the smoke chamber.

Limiting egress of air and smoke leaving the smoke chamber to a point below the lowest portion of the smoke chamber results in a cooking smoker which provides “zero draft” without motive power to move the air and smoke out through the chimney. Zero draft means that there is no or essentially no passive flow of air and smoke through the cooking smoker between its air inlet and the chimney through which air exits while fuel is burning in the fire box. Because heated air rises relative to less heated air, the air and smoke within the smoke chamber becomes air locked and substantially trapped within the smoke chamber absent a motive force to flow the air and smoke through the cooking smoker.

The flow of air and smoke through the cooking smoker of the present invention is governed by an air mover, such as a fan, which provides motive force to flow the air and smoke through the cooking smoker and out through the chimney. When the fan is turned off for a period of time, the combustible fuel in the fire box will self-extinguish due to a lack of fresh oxygen entering the fire box.

The cooking smoker of the present invention also provides for control of cooking temperature by controlling air flow through the cooking smoker. Increasing air flow via the fan will increase cooking temperature within the smoke chamber while decreasing air flow will decrease cooking temperature.

In preferred embodiments, temperature within the cooking chamber is controlled by a controller which senses temperature and, in response, adjusts air flow. The controller may be a PID (proportional-integral-derivative) controller. The controller is operably associated with a temperature sensor which senses temperature within the smoke chamber and provides a signal representative of the measured temperature to the controller. The controller is also operably associated with the fan to operate the fan in accordance with preprogrammed instructions.

In preferred embodiments, the fire box includes a removable fuel tray and removable ash pan. The ash pan underlies the fuel tray within the fire box. The fuel tray retains fuel to be burned, including charcoal, wood, smoking chips and the like. In particular embodiments, the fuel tray includes a projection feature which allows for ease of igniting fuel within the fuel tray. A projection extends outwardly from one of the side walls of the fuel tray. The projection is divided vertically into upper and lower compartments by a separator shelf having a one or more perforations therein to permit flow of air and heat. The inventor has found that it is convenient to light fuel within the fuel tray by placing an amount of fuel in the upper compartment and an amount of tinder within the lower compartment. Igniting the tinder in the lower compartment will in turn light the fuel in the upper compartment as heat and fire are transmitted through the separator shelf.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is a front, isometric view of an exemplary cooking smoker constructed in accordance with the present invention.

FIG. 2 is a front view of the cooking smoker shown in FIG. 1, now with front doors removed.

FIG. 3 illustrates an exemplary fuel tray apart from other components of the cooking smoker.

FIG. 4 is a cross-sectional view of the cooking smoker of FIGS. 1-2 in a zero draft condition.

FIG. 5 is a cross-sectional view of the cooking smoker now illustrating flow of air and smoke for the cooking smoker under induced air flow condition.

FIG. 6 is a schematic diagram of the controller and associated components.

### DETAILED DESCRIPTION OF THE PREFERRED EMBODIMENTS

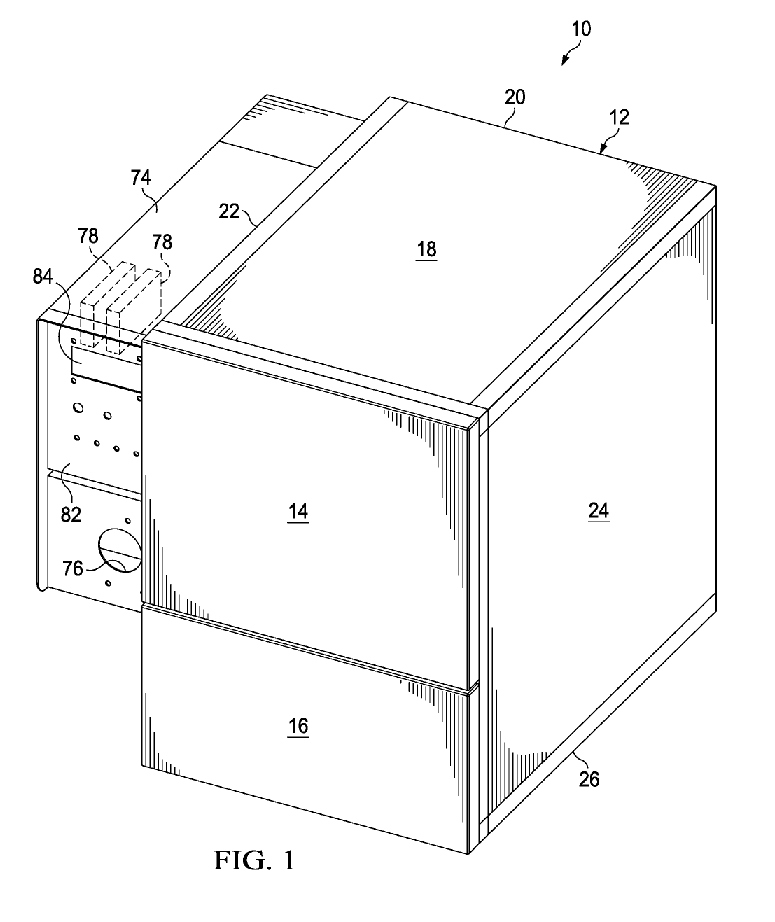

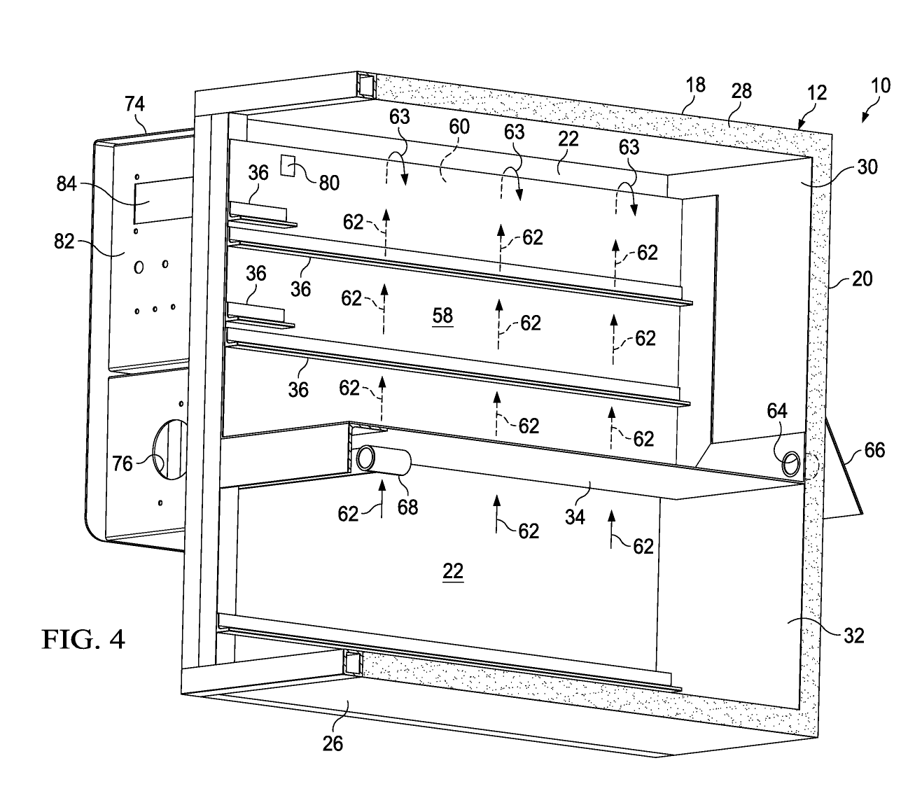

FIGS. 1-2 and 4-5 depict an exemplary cooking smoker 10 having an outer housing 12. FIG. 1 shows the housing 12 with doors 14, 16 affixed which can be opened or closed in a known manner to provide access to the interior of the housing 12. The doors 14, 16 are provided with hinges and closure latches (not shown) as are known in the art for securing the doors 14, 16 in closed positions. The housing 12 is shown to have a generally rectangular or box-like shape. It will be understood, however, that the housing 12 may have other shapes. The depicted housing 12 features a top panel 18, a back panel 20, two lateral side panels 22, 24 and a bottom panel 26. Each of these panels 18, 20, 22, 24, 26 is preferably formed of aluminum, steel, iron, or other metal or ceramic material. The panels 18, 20, 22, 24, 26 may also be filled with insulation of a type known in the art, to help ensure that heat is retained within the housing 12 and that the outside of the housing 12 is less dangerous to touch during use. FIG. 4 depicts insulation 28 within several of these panels in this manner.

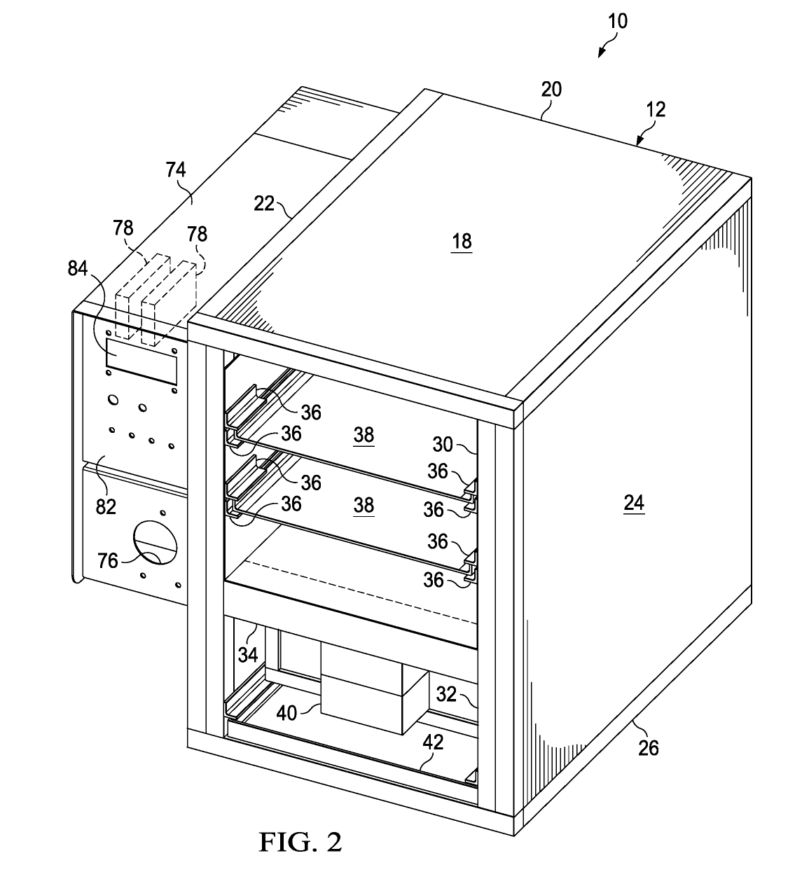

FIG. 2 depicts the cooking smoker 10 with the doors 14, 16 removed to show the interior features. The housing 12 of the cooking smoker 10 encloses an upper smoke chamber 30 and a lower fire box 32. The smoke chamber 30 and fire box 32 are separated by a bulkhead 34. Preferably, the smoke chamber 30 includes support brackets 36 which support grates or trays 38 to hold food.

The fire box 32 preferably retains a removable fuel tray 40 and a separate ash pan 42. The ash pan 42 is also preferably removable from the fire box 32. As is apparent from FIG. 2, the ash pan 42 is retained below the fuel tray 40 within the fire box 32. The fuel tray 40 may be filled with charcoal, wood, smoking chips and other materials useful for cooking and smoking foods.

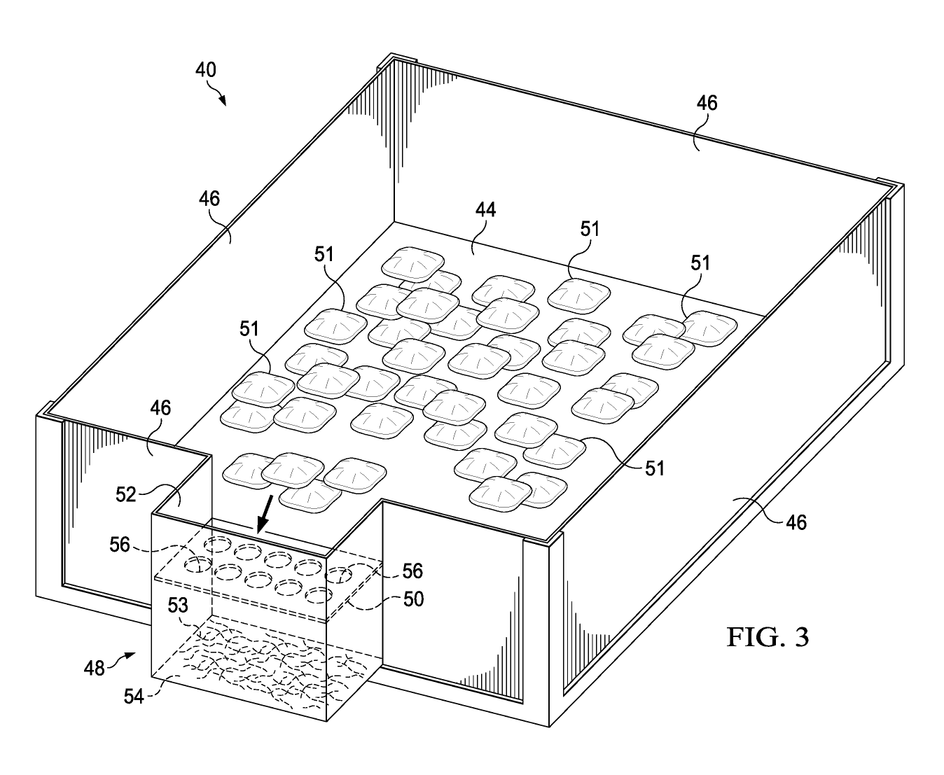

An exemplary fuel tray 40 is illustrated in FIG. 3. The fuel tray 40 preferably includes a rectangular lower panel 44 with tray sides 46 that extend upwardly from the lower panel 44. The lower panel 44 and tray sides 46 are preferably formed of heat-resistant metal, such as steel or aluminum. The sides 46 preferably have perforations or openings therein to allow air flow and heat transfer. The arrangement of an upper fuel tray 40 and lower ash pan 42 allows for easy lighting of charcoal or other fuel which is retained within the fuel tray 40. Newspaper or other tinder material can be placed on the ash pan 42 and lit. The burning tinder material will then ignite the fuel in the fuel tray 40 above.

The fuel tray 40 also preferably features a box-like projection 48 which extends outwardly from one of the tray sides 46. The projection 48 includes a dividing shelf 50 which separates the projection 48 into upper and lower chambers 52, 54, respectively. Dividing shelf 50 preferably has a number of perforations 56 to promote flow or air and heat through the dividing wall. The inventor has found that it is effective to ignite charcoal or other combustible fuel 51 by placing it in the upper chamber 52 and placing tinder material 53, such as newspaper, in the lower chamber 54. Lighting the tinder in the lower chamber 54 will cause the fuel in the upper chamber 52 to then ignite and burn.

Referring now to FIG. 4, the smoke chamber 30 is preferably provided with inner side walls 58 on either lateral side of the smoke chamber 30 which carry the support brackets 36. The inner side walls 58 are separated from the outer housing 12. As can be seen from FIG. 4, inner side wall 58 is spaced apart from side panel 22 to form a smoke channel 60 therebetween which will allow for flow of air and smoke upward from the fire box 32 around the smoke chamber 30 and to enter the smoke chamber 30 from above the support brackets 36 (and food), as illustrated by arrows 62. FIG. 4 illustrates a single inner side wall 58. It should be understood, however, that there is preferably also an inner side wall 58 for the opposite lateral side panel 24 of the outer housing 12.

A chimney 64 is preferably located at or proximate the lower portion of the smoke chamber 30 allowing air and smoke to pass through the back panel 20. Preferably also, a chimney hood 66 is disposed around the chimney 64 on the exterior surface of the back panel 20 to at least partially cover the chimney 64. An air inlet 68 communicates outside air into the fire box 32. In preferred embodiments, the air inlet 68 is the sole passage for outside air to enter the fire box 32 or the smoke chamber 30. The chimney 64 is located upon the cooking smoker 10 at a vertical height that is at or below the vertical height of the air inlet 68. The chimney hood 66 forces air or smoke trying to exit the smoke chamber 30 to have to flow below the level of the bulkhead 34 (the bottom of the smoke chamber 30). In preferred embodiments, the chimney 64 is the sole passage for air and smoke within the cooking smoker 10 to exit the smoke chamber 30. As a result, during cooking or smoking, when fuel is being burned within the fire box 32, air and smoke will be trapped within upper portions of the smoke chamber 30 unless actively moved by motive force. In other words, the cooking smoker 10 will have zero draft when fuel is burned and, without movement of air and smoke by motive force, any fuel burning within the fire box 32 will be extinguished in a short amount of time. This zero draft condition is illustrated in FIG. 4 where heated air and smoke rises from the fire box 32 through the smoke channel 60 to the upper portion of the smoke chamber 30, as indicated by arrows 62. As the air and smoke cool, they will sink into the smoke chamber 30 as indicated by arrows 63 where they are trapped. This is a zero draft condition wherein essentially no air and smoke exit the smoke chamber 30 through the chimney 64.

An air flow control assembly 74 forms a portion of the housing 12. The air flow control assembly 74 includes a fan or other air movement device 76. The fan 76 can be actuated to flow outside air through the air inlet 68 and into the fire box 32. The fan 76 is preferably a multi-speed fan which is capable of operating at a low speed and at a higher speed. More preferably, the fan 76 is a multi-speed fan which is capable of operating at a range of speeds between a minimum speed and a maximum speed.

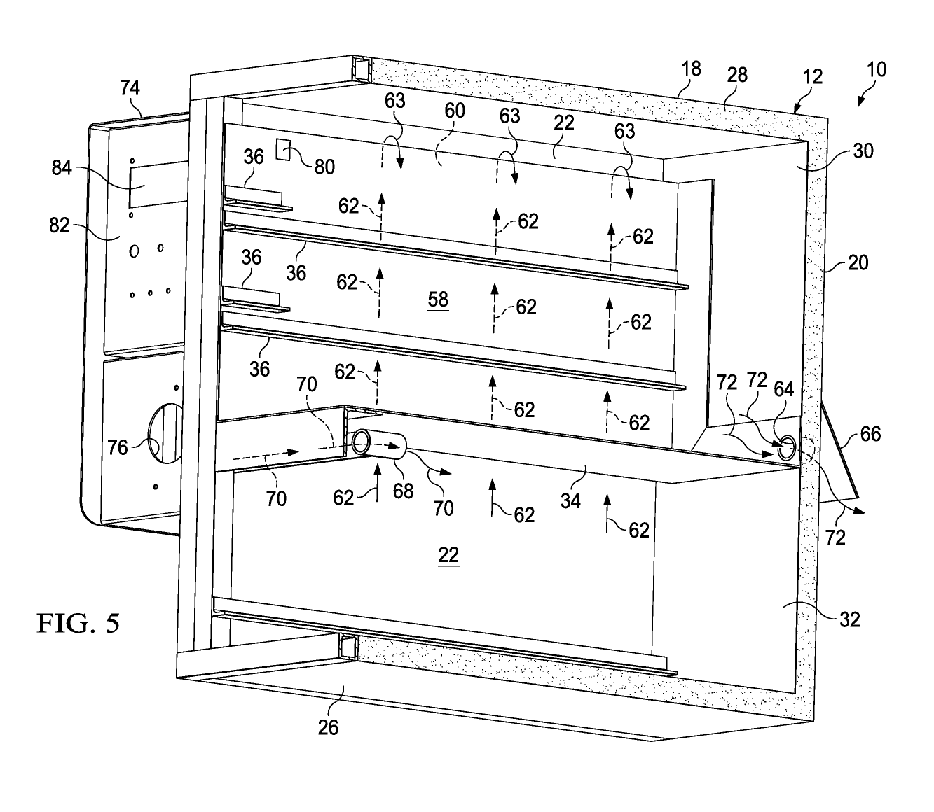

FIG. 5 illustrates the flow of air and smoke through the cooking smoker 10 under impetus of the fan 76. Fan flows air into the fire box 32 through the air inlet 68, as indicated by arrows 70. Air displacement urges more heated air upwardly in the direction indicated by arrows 62 and causes air and smoke within the smoke chamber 30 to exit via the chimney 64, as illustrated by arrows 72. The chimney hood 66 directs exit of air and smoke to exit the cooking smoker 10 below the level of the bulkhead 34.

A controller 78 is preferably located within the air flow control assembly 74. Controller 78 may include a programmable processor which is provided with suitable programming and memory. In certain embodiments, the controller 78 comprises a PID (proportional-integral-derivative) controller which is capable of receiving signals representative of temperature and processing these signals. The controller 78 is also capable of providing control commands to the fan 76 which will enable the speed of the fan 76 to be adjusted.

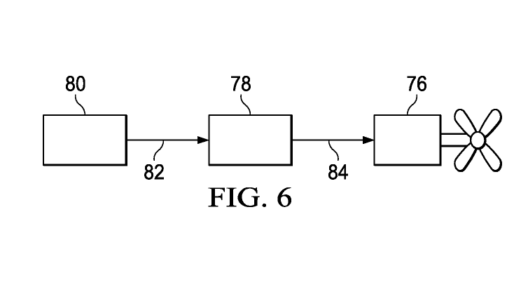

A temperature sensor 80 is located within the smoke chamber 30 and is operably interconnected with the controller 78 to provide a signal to the controller 78 which is indicative of the temperature within the smoke chamber 30. A wired or wireless interconnection may be used between the controller 78 and the sensor 80 to allow communication of the signal to the controller 78 as well as between the controller 78 and the fan 76. These connections are shown schematically at 82, 84, respectively, in FIG. 6.

Cooking temperature within the cooking smoker 10 can be controlled by controlling the fan 76. An increase of fan speed will increase flow of air into the fire box 32 and increase consumption (burning) of fuel within the fuel tray 40, thereby raising the temperature within the smoke chamber 30. Conversely, a decrease of fan speed will decrease flow of air into the fire box 32 and will lower cooking temperature within the smoke chamber 30. Further, turning the fan 76 off will extinguish the burning of fuel within the fire box 32.

The controller 78 may be programmed to maintain cooking temperature within the smoke chamber 30 at or near a preprogrammed set point (i.e, 250° F.). Alternatively, the controller 78 may be programmed to maintain cooking temperature within a particular range of temperatures (i.e., between 240°-250° F.). Preferably, the air flow control assembly 74 includes a control interface 82 having buttons, toggles, knobs or the like which allow a user to adjust the controller settings for desired temperature as well as a display 84 which can display temperature setpoints, actual measured temperature and/or fan speed. The controller 78 can perform iterative comparisons of sensed temperature to preprogrammed temperature set point(s) and, in response, increase or decrease the speed of fan 76.

In preferred methods of operation, the controller 78 will preferably actuate the fan 76 to operate at preprogrammed intervals to prevent fuel within the fire box 32 from self-extinguishing. As one example, the controller 78 will actuate the fan 76 for one second at 20% of its maximum speed at intervals of every 45 seconds.

An electrical power source (not shown) is included within the housing 12 to provide electrical energy for operation of the fan 76 as well as the controller 78. The electrical power source may be in the form of a battery, a/c plug to external power outlet, solar or other power sources.

It should be understood that the present invention also provides a method for operating a cooking smoker 10. In accordance with this method, a combustible fuel 51 is ignited within the fire box 32 to create heated air and smoke. The heated air and smoke rises from the fire box 32 into the smoke chamber 30, as FIG. 4 depicts. The heated air and smoke is trapped within the smoke chamber 30 in a zero draft condition wherein the heated air and smoke does not exit the smoke chamber 30. Next, outside air is flowed into the fire box 32 through the air inlet 68 to displace a portion of the heated air and smoke from the smoke chamber 30 through the chimney 64, wherein the chimney 64 is at a vertical height which is at or below the air inlet 68. In preferred embodiments, the step of flowing the outside air into the fire box 32 is performed by actuating the fan 76. In further preferred embodiments, the fan is actuated by the controller 78.

What is claimed is:

1. A cooking smoker comprising:
a housing which defines a smoke chamber within to place food for cooking and smoking;
a fire box defined within the housing and separated from the smoke chamber by a bulkhead, the fire box being adapted to retain fuel to burn and create smoke;
an air inlet to flow outside air into the fire box;
a chimney in the housing for removing air and smoke from the smoke chamber; and
a fan which is actuated to cause air to flow into the air inlet and out of the chimney.

2. The cooking smoker of claim 1 further comprising:
a temperature sensor for sensing temperature within the smoke chamber; and
a controller operably associated with the temperature sensor and the fan to receive a signal from the temperature sensor representative of the temperature within the smoke chamber, and in response thereto, control the fan.

3. The cooking smoker of claim 1 further comprising a fuel tray which is removable from the fire box, the fuel tray having:
a bottom panel;
a plurality of tray sides which extend upwardly from the bottom panel;
a projection extending from a tray side;
a dividing shelf which separates the projection into an upper chamber and a lower chamber;
a plurality of perforations disposed within the dividing shelf; and
whereby fuel placed within the upper chamber can be ignited by lighting of tinder within to the lower chamber.

4. The cooking smoker of claim 2 wherein control of the fan adjusts the cooking temperature within the smoke chamber.

5. The cooking smoker of claim 1 wherein the fan is a multi-speed fan.

6. The cooking smoker of claim 1 wherein the chimney is located at or below the air inlet such that there is zero draft air flow through the smoke chamber and fire box absent motive force to displace air through the chimney.

7. The cooking smoker of claim 1 further comprising a chimney hood partially covering the chimney which directs exit of air from the chimney below the bulkhead.

8. A cooking smoker comprising:
a housing which defines a smoke chamber to place food for cooking and smoking;
a fire box defined within the housing and separated from the smoke chamber by a bulkhead, the fire box being adapted to retain fuel to burn and create smoke;
an air inlet to flow outside air into the fire box;
a chimney in the housing for removing air and smoke from the smoke chamber; and
wherein the chimney is located upon the housing at or below the vertical height of the air inlet so that a zero draft condition is created within the smoke chamber absent a motive force to displace air and smoke from the smoke chamber.

9. The cooking smoker of claim 8 further comprising a fan to flow air into the fire box and displace air and smoke within the smoke chamber out of the chimney.

10. The cooking smoker of claim 9 wherein the fan is a multi-speed fan.

11. The cooking smoker of claim 9 further comprising:
a temperature sensor to detect temperature within the smoke chamber; and
a controller which is operably associated with the temperature sensor and the fan, the controller operating the fan in response to a signal provided by the temperature sensor which is representative of the detected temperature.

12. The cooking smoker of claim 8 further comprising a, fuel tray which is removable from the fire box, the fuel tray having:
a bottom panel;
a plurality of tray sides which extend upwardly from the bottom panel;
a projection extending from a tray side;
a dividing shelf which separates the projection into an upper chamber and a lower chamber;
a plurality of perforations disposed within the dividing shelf; and
whereby fuel placed within the upper chamber can be ignited by lighting of tinder within the lower chamber.

13. The cooking smoker of claim 11 wherein the temperature sensor and controller are retained within an air flow control assembly which is integrated into the housing of the cooking smoker.

14. A method of operating a cooking smoker having a housing which defines a smoke chamber to place food for cooking and smoking and a fire box defined within the housing below the smoke chamber and separated from the smoke chamber by a bulkhead, the method comprising the steps of:
Igniting a combustable fuel within the fire box to create heated air and smoke;
allowing the heated air and smoke to rise into the smoke chamber;
trapping the heated air and smoke within the smoke chamber in a zero draft condition wherein the heated air and smoke does not exit the smoke chamber; and
flowing outside air into the fire box through an air inlet to displace a portion of the heated air and smoke from the smoke chamber through a chimney, wherein the chimney is at a vertical height which is at or below the air inlet.

15. The method of claim 14 wherein the step of flowing outside air into the fire box further comprises actuating a fan.

16. The method of claim 15 wherein the fan is actuated by a controller which actuates the fan in response to temperature detected within the smoke chamber.
